(19) United States
(12) Patent Application Publication
(10) Pub. No.: US 2015/0049593 A1
(43) Pub. Date: Feb. 19, 2015

(54) METHOD FOR ENGRAVING A TIMEPIECE COMPONENT AND TIMEPIECE COMPONENT OBTAINED USING SUCH A METHOD

(71) Applicant: ROLEX SA, Geneva (CH)

(72) Inventor: Alexandre Oliveira, Annecy (FR)

(73) Assignee: ROLEX SA, Geneva (CH)

(21) Appl. No.: 14/384,250

(22) PCT Filed: Mar. 12, 2013
(86) PCT No.: PCT/EP2013/055008

§ 371 Date: Sep. 10, 2014

(30) Foreign Application Priority Data
Mar. 12, 2012 (EP) 12159120.0
Jun. 18, 2012 (EP) 12172383.7

(51) Int. Cl. B44C 1/22; B23K 26/08; B23K 26/06; G04D 99/00

(52) U.S. Cl. CPC B44C 1/228; G04D 99/00; B23K 26/0807; B23K 26/06
USPC 368/276; 219/121.69

(57) ABSTRACT

Method for engraving a component (1; 3) involving application to the component of a laser beam (5) the pulses of which each last less than one picosecond, so as to machine or remove material from the component and achieve coloration of the surface (6) in the bottom of the machining

The invention relates to a process for engraving and especially to a process for engraving and coloring a component. The invention also relates to an element or a component, in particular a timepiece element, especially a watch element, obtained by implementing such a process. The invention furthermore relates to a timepiece, especially a watch, comprising such an element.

When it is desired to produce a recess having a colored bottom in a steel component, machining and chemical engraving and coloring processes, which require the use of masks and highly toxic compounds such as chromium Cr(VI), are conventionally used to obtain a good result. Apart from problems associated with the use of toxic compounds, these processes are time-consuming and difficult to implement because they involve a number of steps.

It will be noted that horology applications place high demands on such processes: an attractive appearance is very important and the engraving and coloring must be free from defects or burrs. The requirements in terms of robustness are also demanding as the components thus engraved and colored are liable to be exterior components that will be subject to shocks and exposed to the environment (bezel, glass, back, middle for example). In any case, the components must undergo thorough cleaning after they have been machined and the coloring must be sufficiently adherent to withstand such processing.

Patent application EP0647720 describes the use of a nanosecond laser with a pulse repetition rate of the order of a kHz, allowing a red color to be obtained on a steel surface, the color depending on the power density.

U.S. Pat. No. 6,180,318 mentions coloring a metal surface with an “imaging layer” comprising a layer of metal and metal oxide. This additional layer is essential if the desired coloring is to be obtained. The document in particular mentions an aluminum/alumina imaging layer.

Document WO9411146 relates to the use of laser pulses that are longer than 5 ns in length to produce (darkly) colored regions on a surface, in particular on a surface comprising a chromium-based coating.

Application WO2011163550 describes obtaining marks on a steel surface with a picosecond laser, on the steel, by creating periodic structures on the surface.

Application WO2008097374 relates to the creation of periodic nanostructures on the surface of a metal sample using a femtosecond laser. These structures allow (black, gray, gold) colors to be obtained and the surfaces to be modified. A black color is obtained on aluminum, the intensity of the blackness depending on the fluence of the laser.

The aim of the invention is to provide a process for engraving a timepiece allowing the aforementioned drawbacks to be remedied and the known processes of the prior art to be improved. In particular, the invention proposes an engraving process that makes it possible to simplify known processes.

An engraving process according to the invention is defined by claim 1.

Various embodiments of the engraving process are defined by dependent claims 2 to 13.

In one variant combinable with the various embodiments, unless technically incompatible, the color of the machined bottom surface may be different from the surface of the component before material is removed.

In one variant combinable with the various embodiments and with the preceding variant, unless technically incompatible, the removal of material and the coloring may be achieved successively.

In one variant combinable with the various embodiments and with the preceding variants, unless technically incompatible, the operating parameters of the beam may be different during the machining and during the coloring.

In one variant combinable with the various embodiments and with the preceding variants, unless technically incompatible, the degree of lateral overlap (or more generally the degree of overlap in another direction) may be lower than 60%, or even about equal to 50%, or even lower than 10%, or even lower than 5%, or even zero or substantially zero.

In one variant combinable with the various embodiments and with the preceding variants, unless technically incompatible, the component may be made of a bulk material.

In one variant combinable with the various embodiments and with the preceding variants, unless technically incompatible, the component may be made of a material comprising at least 75% by weight gold.

In one variant combinable with the various embodiments and with the preceding variants, unless technically incompatible, the beam may be focused on the surface of the component or substantially on the surface of the component.

In one variant combinable with the various embodiments and with the preceding variants, unless technically incompatible, the removal of material and the coloring may be achieved without external addition of material.

In one variant combinable with the various embodiments and with the preceding variants, unless technically incompatible, the removal of material may cause a recess to be produced with a depth larger than 10 μm and in particular larger than 40 μm.

In one variant combinable with the various embodiments and with the preceding variants, unless technically incompatible, the coloring of the machined bottom surface may produce a black color or a white color.

In one variant combinable with the various embodiments and with the preceding variants, unless technically incompatible, the repetition frequency of the pulses may be comprised between 1 kHz and 300 kHz.

In one variant combinable with the various embodiments and with the preceding variants, unless technically incompatible, the wavelength of the laser may be comprised between 300 nm and 1100 nm.

In one variant combinable with the various embodiments and with the preceding variants, unless technically incompatible, the power of the beam may be comprised between 1 W and 6 W, for example 1.4 W at 1 kHz and 5.5 W at 300 kHz.

In one variant combinable with the various embodiments and with the preceding variants, unless technically incompatible, the energy of the pulses may be comprised between 0.5 μJ and 2 mJ and in particular between 5 μJ and 100 μJ.

In one variant combinable with the various embodiments and with the preceding variants, unless technically incompatible, the energy of the beam may be adjusted using a half-wave plate and/or a beam-splitting polarizer cube, the half-wave plate allowing the linear polarization of the beam to be rotated and/or the polarizer cube allowing the polarization parallel to the plane of propagation of the beam to be transmitted and the polarization perpendicular to the plane of propagation to be deflected.

In one variant combinable with the various embodiments and with the preceding variants, unless technically incompatible, the laser beam may be moved over the component along curves, and in particular lines, that are parallel or substantially parallel.

In one variant combinable with the various embodiments and with the preceding variants, unless technically incompatible, the laser beam may be moved over the component along curves, in particular lines, oriented differently in the various passes of the process. In particular, the laser beam may be moved along lines making an angle, especially a right angle, in the successive passes of the process.

In one variant combinable with the various embodiments and with the preceding variants, unless technically incompatible, the diameter of the laser beam may be comprised between 5 μm and 60 μm, in particular between 20 and 30 μm and is especially about 30 μm and in particular 27 μm.

In one variant combinable with the various embodiments and with the preceding variants, unless technically incompatible, the beam may be moved at a speed lower than 250 mm·s⁻¹, in particular lower than 200 mm·s⁻¹.

In one variant combinable with the various embodiments and with the preceding variants, unless technically incompatible, the laser beam may be moved over the component in a number of passes, in particular about 10 passes or about 20 passes.

In one variant combinable with the various embodiments and with the preceding variants, unless technically incompatible, the removal of material causes a recess to be produced with an average depth larger than or equal to 4 μm per pass and in particular larger than or equal to 8 μm per pass.

Unless technically incompatible, all the features of the preceding variants and/or preceding embodiments may be freely combined together.

An element or component according to the invention is defined by claim 14 or 15.

A clock mechanism according to the invention is defined by claim 16.

A timepiece according to the invention is defined by claim 17.

The appended drawings show, by way of example, illustrations of embodiments of an engraving process according to the invention.

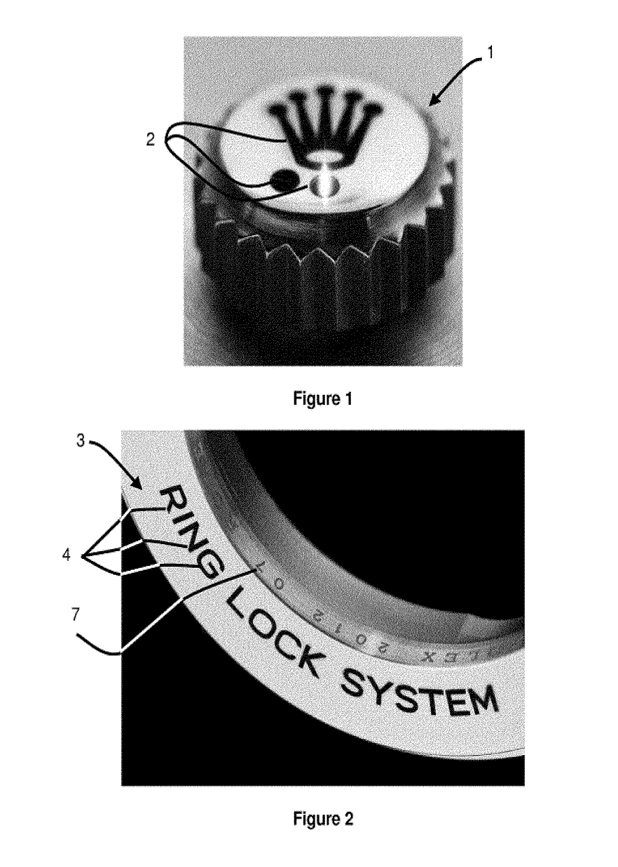

FIG. 1 is a crown obtained by the engraving process according to the invention.

FIG. 2 is a component obtained by the engraving process according to the invention.

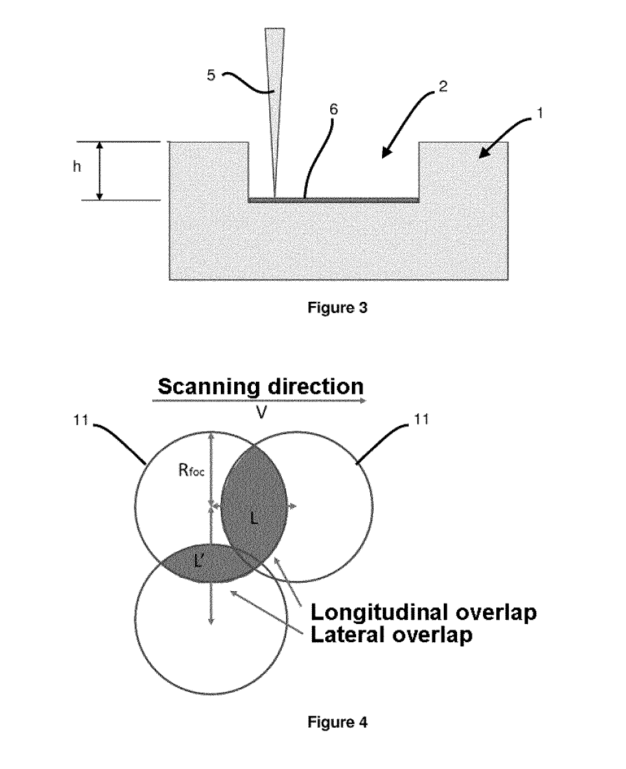

FIG. 3 is a schematic diagram of the engraving process according to the invention.

FIG. 4 illustrates the main features of a spatial representation, on an engraved component, of impacts due to laser pulses.

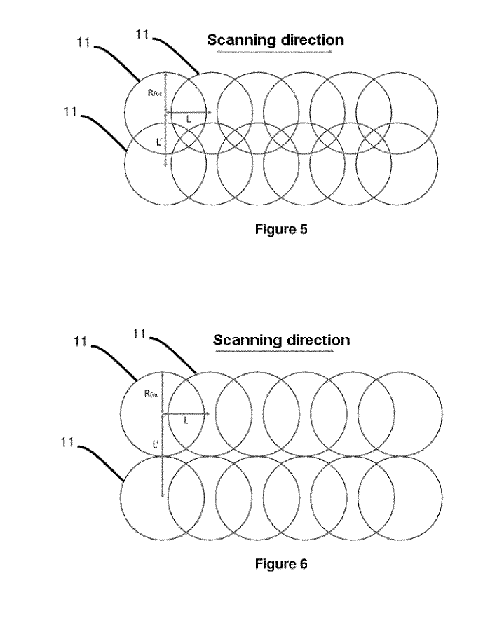

FIG. 5 illustrates a first spatial representation, on an engraved component, of impacts due to laser pulses.

FIG. 6 illustrates a second spatial representation, on an engraved component, of impacts due to laser pulses.

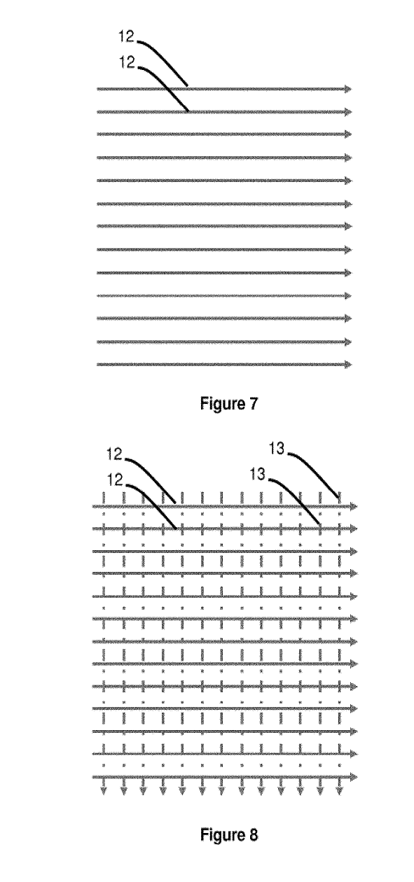

FIG. 7 illustrates a first laser-beam scanning mode intended to produce a recess by applying the process according to the invention.

FIG. 8 illustrates a second laser-beam scanning mode intended to produce a recess by applying the process according to the invention.

In one embodiment of the process according to the invention the possibilities made available by femtosecond-laser machining are used to engrave and color, in a single operation, a component or an element made of a metallic or nonmetallic bulk material. Thus, this process allows recesses to be produced the bottom surface of which exhibits a different color to the original color of the material without adding extra material, and in particular black surfaces to be produced on gold, platinum, steel or titanium. This development is a novel application of conventional femtosecond-laser machining and allows, in a single operation, a recess to be produced in a metal component and the bottom thereof to be colored.

It is thus possible to produce recesses in a substrate, especially a metal substrate, for example made of steel, titanium, gold or platinum, the bottoms of which are colored black, in a single femtosecond-laser machining operation and without adding material.

It is also possible to produce recesses in a substrate, especially a substrate made of ceramic or glass, for example of zirconia, alumina or sapphire, the bottoms of which are colored white, in a single femtosecond-laser machining operation and without adding material.

In one embodiment of the process for engraving a component, a laser beam is applied to the component, the pulses of the laser beam each lasting less than one picosecond, so as to machine or remove material from the component and color the machined bottom surface. A femtosecond laser is therefore used.

This technique allows, in a single processing step, patterns to be produced rapidly, reliably, reproducibly and without using environmentally unfriendly products.

A femtosecond laser is a particular type of laser that produces ultrashort pulses that are about a few femtoseconds to a few hundreds of femtoseconds in length (1 fs=1 femtosecond=10⁻¹⁵ seconds). The terms “femtosecond laser” and “femtosecond pulsed laser” are used interchangeably.

Combining the two steps of engraving and coloring in a single processing step requires the use of an ultrashort pulsed laser, especially a femtosecond pulsed laser. This is because it is crucial to use very short pulses, shorter than a picosecond in length, in order to minimize damage to the material.

In contrast to what was sought in the prior art, namely to obtain periodic structures, periodic structures are not necessarily desired because the colors obtained may depend on viewing angle.

The engraved component may be of various types, in particular, it may be a crown 1 of a winding mechanism, a component of a timepiece exterior 3, for example a bezel, flange or a watch casing back, a casing or watch-wristlet component or indeed a component of a clock movement such as, for example, a movement blank, plate, bridge, wheel or even a lever.

FIG. 1 shows a crown of a winding mechanism in the process of being engraved by applying the process according to the invention. Recesses 2, forming a pattern, have already been partially produced. The bottom of these recesses exhibits a surface having a different color and appearance to the other surfaces of the material, in this case a black color.

FIG. 2 shows a component 3 after it has been engraved by applying the process according to the invention. Recesses 4 have been produced, forming a pattern.

FIG. 3 shows a cross-sectional schematic diagram of the engraving process according to the invention. The component 1 is impacted by a laser beam 5. These impacts allow a recess 2 of average depth h to be produced and the bottom 6 of this recess to be colored.

The laser used in the experiments described below is a femtosecond laser (for example from the manufacturer Amplitude Systèmes as described on the website http://www.amplitude-systemes.com/) that delivers 450 fs length pulses with a variable repetition rate that may be adjusted between 1 and 300 kHz. The wavelength used is 1030 nm, but it may be changed to 515 nm or 343 nm by way of a frequency doubler or tripler generating a second or third harmonic. The average power delivered is typically 1.4 W for a repetition rate of 1 kHz and 5.5 W for a repetition rate of 300 kHz. The average energy is adjustable between 18μJ and 1.4 mJ, and the polarization at the exit of the laser is linear.

The optical system for shaping the beam is composed of various elements allowing the delivered energy, the polarization and the size of the beam to be adjusted. The energy-adjusting module is made up of a half-wave plate and a beam-splitting polarizer cube. The half-wave plate allows the linear polarization of the laser beam to be rotated. The polarizer cube will transmit the polarization parallel to the plane of propagation of the beam and deflect the polarization perpendicular to the plane of propagation. This device therefore allows the energy delivered by the laser for the machining to be selected with precision. A quarter-wave plate placed after the energy-adjusting module allows the linear polarization of the laser beam to be changed to a circular polarization. The effectiveness of the ablation is directly affected by the orientation of the linear polarization relative to the path traced, and the use of a circular polarization ensures this effect does not lead to nonuniformity. However, the invention may employ either a linear polarization or a circular polarization.

Next, an afocal system composed of two lenses (a divergent lens and a convergent lens) allows the size of the beam to be increased before focusing. The increase in the size of the beam before focusing allows the final size of the focused beam to be decreased. The trials were carried out with an afocal between ×2 and ×8.

A workstation equipped with linear translation and rotation stages, a scanning module, a microscope-type viewing system allowing the samples to be positioned with precision, an illuminating system and a system for vacuuming up dust was used.

The beam is scanned over the target by an optical beam-deviating device that is electronically controlled. It allows the desired patterns to be produced via a control software. The scan head used is an IntelliScan head from ScanLab. The aperture of the scanner is 14 mm and attainable marking speeds are about 4 m/s for a positioning speed of 11 m/s. The lenses used with the scanning module are f-theta lenses or telecentric lenses. The f-theta and telecentric lenses allow a focal plane to be obtained everywhere in the XY field, contrary to standard lenses for which it is curved. This makes it possible to guarantee a constant focused beam size everywhere in the field. For f-theta lenses, the position of the beam is directly proportional to the angle applied by the scanner whereas the beam is always normal to the sample for telecentric lenses. Two lenses were tested in the trials, an f-theta lens with a focal length of 100 mm and a telecentric lens with a focal length of 60 mm. The 100 mm lens is preferably used.

The scanning of the beam over the target has a substantial effect on the result obtained. Specifically, the scanning speed used and the pitch of the scanning are critical if simultaneous engraving and coloring is to be obtained.

FIG. 4 shows the position of three laser-pulse impacts 11 on the component or target. Two immediately successive impacts are aligned in a first direction and separated by a distance L (measured between the centers of two successive impacts). This distance depends on the repetition rate T and on the scanning speed V (i.e. the speed of movement in the first direction) where L=V/T. For example, if V=100 mm/s and T=100 kHz, as in most of our trials, L=1 μm. R_{foc} is the radius of the beam on the target or component, measured at half-maximum (the diameter of the beam is designated D_{foc}=2·R_{foc}). Preferably, the beam is focused on the surface of the component to be machined.

Once a scan line has terminated (in the first direction), the beam is moved a distance L′ in a second direction perpendicular to the first scanning direction in order to initiate the machining of a new scan line: this distance L′ is also referred to as the “scanning pitch”.

The distance L allows a degree of longitudinal overlap to be defined and the distance L′ allows a degree of lateral overlap to be defined. These degrees of overlap are representative of the area common to two adjacent impacts in the first direction (scanning direction) and in the second direction. The degree of longitudinal overlap O (i.e. in the first direction) is given by:

$$O = \frac{2 {R}_{foc}^{2} Arcsin ( \frac{{h}_{1}}{{R}_{foc}} ) - {h}_{1} L}{π {R}_{foc}^{2}}$$

if 2·R_{foc}≧L (O=0 if 2·R_{foc}<L) , where

$${h}_{1} = \frac{1}{2} \sqrt{4 {R}_{foc}^{2} - {L}^{2}} .$$

The degree of lateral overlap O′ (i.e. in the second direction) is defined in an analogous way, with L′ instead of L in the above formulae.

Thus it is possible to perform scans with comparable degrees of longitudinal and lateral overlap, as shown in FIG. 5, or very different degrees of longitudinal and lateral overlap, as shown in FIG. 6 (in which the degree of lateral overlap is almost zero).

It has been observed that the degree of longitudinal overlap and the degree of lateral overlap may be interchanged without affecting the result obtained: the effect obtained by carrying out a scan with a given degree of longitudinal overlap O=t1 and of lateral overlap O′=t2 is thus substantially equivalent to the effect obtained by carrying out a scan with a degree of longitudinal overlap t2 and of lateral overlap t1.

In addition, a scan may be carried out in the first direction 12 only (as shown in FIG. 7, also referred to as “hatch” or “simple-hatch” scanning) or in the first direction 12 then in another direction 13 that for example is perpendicular (“0-90° crosshatch” as shown in FIG. 8) or at 45°. The micron-sized patterns obtained on the surface will obviously not be the same. There are a large number of possible scanning strategies, and that used depends a lot on the material.

The main parameters influencing the process are:
The power of the beam at the target. The laser generally always emits at maximum power, the emitted beam being attenuated once output from the laser by an optical system composed of a linear polarizer and a polarizer cube.
The diameter of the beam at the target, which is adjusted by way of diaphragms placed on the optical path before the focusing lens. Decreasing the beam diameter before the optical system results in an increase in the diameter of the beam on the target. For example, in the machine used for the trials, a diameter of 10 mm before the focusing lens produces an average beam diameter on the target of 27 μm. Other trials were carried out with an average beam diameter on the target of 21 μm. The beam diameter indicated is the average diameter at half-maximum, such as measured by a standard beam analyzer.
The pulse repetition rate, which is adjustable in the system used.
The average energy per pulse, which corresponds to the power divided by the frequency. An effective fluence is deduced therefrom, equal to the energy divided by the area (calculated as π·R_{foc}²)
The pulse length, equal to 450 fs in most of the trials. Another laser, delivering a pulse length of 200 fs allowed equivalent results to be obtained once suitable changes had been made to the other parameters. In this respect, the power density, equal to the effective fluence times the pulse length, may be considered. Taking the conditions shown in table 1 by way of example the average energy is 38.6 μJ, the effective fluence is 6.6 J/cm², and the power density is 14.6×10¹² W/cm². In the trials, a power density higher than 3×10¹² W/cm² is preferable to obtain satisfactory results.
The wavelength of the beam. In general, the wavelength of 1030 nm delivered by the laser is used in order to deliver the highest possible power. However, with certain materials, such as sapphire, it may be advantageous to use a wavelength of 343 nm in the UV where absorption is clearly much higher for this material, as a much higher ablation speed is then obtained despite the high power loss induced by the frequency tripling.
The degrees of longitudinal and lateral overlap are the most important parameters as regards the coloring. The influence of the type of scan is in most cases of secondary importance, but it may help to obtain a better result.

The scanning speed defines the degree of overlap directly if the repetition rate of the pulses and the diameter of the beam are fixed. Normally, the highest possible repetition rate and the smallest possible beam diameter are chosen in order to minimize machining time and maximize fluence, respectively, and it is therefore the scanning speed that will define the degree of overlap.

During laser machining according to the prior art, the scanning speed is as high as possible in order to obtain high ablation rates, and therefore rapid machining speeds. Under the conditions given in table 1, such a machining speed would be 1000 mm/s, thereby allowing clean and rapid engraving—but however without significant coloring of the bottom of the recess (see for example the alphanumeric characters 7 engraved on the interior surface of the component in FIG. 2).

Contrary to what is widely accepted, we have observed that decreasing the scanning speed allows a good ablation to be obtained while producing a black color at the recess bottom. This is the case, for example, with the conditions summarized in table 1 below, with a scanning speed 10 times lower than the speed suitable for a traditional machining operation using a femtosecond pulsed laser. These conditions were especially used to obtain the pattern on the crown in FIG. 1, and the letters engraved on the upper surface 3 of the component in FIG. 2. This image clearly shows the difference between the result obtained with a standard scanning speed (standard machining conditions) and our conditions for engraving and coloring at the same time, ablation conditions remaining unchanged.

TABLE 1
typical conditions with the equipment and optical assembly used to
obtain an engraving with a colored engraving bottom on P558 steel.

| | Average diameter | | |
|---|---|---|---|
| P on the | of the beam at | Repetition | Scanning |
| target [W] | the target [μm] | rate [kHz] | strategy |
| 3.86 | 27.3 | 100 | Crosshatch |
| | | | 0-90 |
| | | Distance | |
| Scanning | Scanning speed | between two | Number of |
| pitch [mm] | [mm/s] | pulses [μm] | passes |
| 0.01 | 100 | 1 | 10 |

The conditions collated in table 1 allow an average recess depth of 90 μm to be obtained on P558 steel, with an excellent definition, an impeccable appearance after cleaning (ultrasound and detergent), and a good durability (no delamination of the coloring under ultrasound, for example). The following observations may be noted:
equivalent simple-hatch scanning gives a very satisfactory result.
a single machining pass alone is enough to obtain a substantial engraving depth (between 4 and 10 μm) and a satisfactory color. In other words, the removal of material causes a recess to be produced with an average depth larger than or equal to 4 μm per pass.

Table 2 summarizes experiments carried out at various scanning speeds and the corresponding degree of longitudinal overlap, and the result in terms of the color. It may be seen that speeds of about 100 mm/s (O=95.3%) are ideal in the present case and that the results at 250 mm/s and above (O≦88.2%) are unsatisfactory. Too low a scanning speed is not advantageous because the coloring is not sufficiently adherent: thus for low speeds (and therefore very high degrees of overlap) the coloring is observed to delaminate during ultrasonic cleaning.

For steel, a degree of overlap higher than 90%, in particular higher than 92%, more particularly higher than 94%, allows recesses to be obtained having a colored engraving bottom in a single processing step, the depth being adjusted by adjusting the number of passes (complete scans) carried out. Of course, the degree of overlap will always be strictly less than 100% (dynamic machining with a moving beam).

TABLE 2
influence of the scanning speed on the black coloring
at the bottom of the engraving on P558 steel.

| Scanning | | | | |
|---|---|---|---|---|
| speed [mm/s] | 100 | 250 | 500 | 1000 |
| Degree of | 95.3 | 88.4 | 76.8 | 54.4 |
| longitudinal | | | | |
| overlap | | | | |
| Result | Black | Unsatisfactory | Slight | Slight |
| | color | grayish color | coloring | coloring |
| | | | or even no | or even no |
| | | | coloring | coloring |

For example, a color is said to be black when the CIE Lab L*a*b* index has a value such that L*<20.

As regards the degree of lateral overlap, the pitch used is L′=10 μm, which leads to a degree O′=54.4%. Increasing the pitch to 20 μm and 30 μm leads to a degree of overlap of 15.2 and 0%, respectively.

We have also observed that it is preferable to focus the beam of the laser on the surface. Under standard machining conditions it is recommended to defocus the beam (therefore to place the focal plane above or below the surface) in order to increase engraving speed.

The depth of the engraving may be adjusted by adjusting the number of passes and therefore the number of repetitions of the scanning pattern: the higher the number of passes, the deeper the engraving. The aspect of the black color also seems to be better when the engraving is deeper.

A femtosecond pulsed laser must be used if an engraving and a colored recess bottom are to be obtained in one and the same operation, and if the appearance of the engraving is to meet the requirements of the watch and clock making industry. With a nanosecond laser for example, engraving would be possible in a first step, but with substantial machining damage that would unacceptably degrade the esthetic aspect of the timepiece component, and the coloring would have to be carried out in a second step using another process. Our trials have shown that the length of the pulses must in any case be shorter than 1 ps. It is thus quite remarkable to note that with the conditions chosen it is possible to engrave and color simultaneously without saturating the ablation.

FIG. 3 illustrates the process: the pulses 5 of the femtosecond laser focused on the surface make it possible both to ablate the material, allowing an engraving to be produced by machining, and to color the bottom of the engraving without adding material, probably by forming a deposit and/or a particular geometric structure at the bottom of the engraving 6.

In addition to P558 steel, 904L steel and titanium were also used, with results that were equivalent in every respect. For titanium the following conditions were particularly advantageous: a power on the target of 2.4 W, a repetition rate of 300 kHz, a 0°-90° crosshatch scanning strategy (perpendicular passes), a scanning pitch of 5 μm, a scanning speed of 400 m/s and 12 passes.

Of course, the conditions will have to be adjusted depending on the type of steel or titanium or other metallic material used, and on the femtosecond laser machining system (laser, wavelength of the beam, pulse length, fluence, optical system, scan head, etc.) considered. In particular, the fluence, the degree of longitudinal and lateral overlap and the scanning strategy will need to be optimized for each material.

Just like on steel, the femtosecond laser allows an engraving to be produced and a black colored recess bottom to be obtained on gold alloys without addition of external material.

According to our trials, to obtain a black colored engraving bottom simultaneously to the ablation it seems to be advantageous to use a simple-hatch scan or crosshatch scan and a very small degree of lateral overlap, even a degree of lateral overlap of close to zero or even zero.

The process allows a black color that is satisfactory in every respect to be obtained on various types of gold, in particular alloys of 18 carat gold, such as yellow, pink or gray gold.

TABLE 3
Conditions used in the trials on gold.

| | P on the | Average diameter | | | Pitch of | Scanning | Distance | |
|---|---|---|---|---|---|---|---|---|
| | target | of the beam at | Repetition | Scanning | the scan | speed | between two | Number of |
| Material | [W] | the target [μm] | rate [kHz] | strategy | [mm] | [mm/s] | pulses [μm] | passes |
| Yellow | 3.86 | 27.3 | 50 | Simple | 0.03 | 10 | 0.2 | 1 |
| gold | | | | hatch | | | | |
| Gray gold | 3.86 | 27.3 | 100 | Simple | 0.03 | 20 | 0.2 | 1 |
| | | | | hatch | | | | |
| Pink gold | 3.86 | 27.3 | 100 | Simple | 0.03 | 20 | 0.2 | 1 |
| | | | | hatch | | | | |

The corresponding degree of longitudinal overlap is 99.1%, the degree of lateral overlap is 0. The average depth obtained is 12 μm on yellow gold, 11 μm on pink gold and 4 μm on gray gold.

The conditions used to obtain an engraving with a colored recess bottom on a component made of Pt950 alloy are similar to those used with Au. Using identical conditions to those given in table 1 for P558 steel an unsatisfactory grayish effect is obtained. If the degree of lateral overlap is decreased (to ˜0%) and the degree of longitudinal overlap increased, for example to higher than 99%, a black color is obtained simultaneously to the ablation, as indicated in the table below.

TABLE 4
Conditions used in the trials on platinum. The corresponding
degree of longitudinal overlap is 99.1%, the degree of lateral
overlap is 0. The average recess depth obtained is 15 μm.

| | Average diameter | | |
|---|---|---|---|
| P on the | of the beam at | Repetition | Scanning |
| target [W] | the target [μm] | rate [kHz] | strategy |
| 3.86 | 27.3 | 100 | Simple hatch |
| | | Distance | |
| Pitch of the | Scanning | between two | Number of |
| scan [mm] | speed [mm/s] | pulses [μm] | passes |
| 0.03 | 20 | 0.2 | 1 |

It is very probable that similar results may be obtained on other metallic materials such as aluminum, Ni or NiP deposited by LIGA, Si or brass.

Of course, the conditions must be adjusted depending on the type of material and on the femtosecond laser machining system (laser, wavelength of the beam, pulse length, fluence, optical system, scan head, etc.) considered. In particular, the fluence, the degree of longitudinal and lateral overlap and the scanning strategy will need to be optimized for each material, especially depending on the equipment and/or the optical assembly used.

In addition it is possible, by virtue of the femtosecond laser, to cleanly engrave a layer deposited on a surface, such as for example a layer of photoresist or a thin film, for example a thin film deposited by electrodeposition, or PVD, or CVD or any other comparable process, then to engrave the base material. This for example allows, in one and the same femtosecond laser machining operation, a steel component coated with an electrodeposited gold layer to be engraved and the bottom of the recess to be engraved and colored.

Is also possible to produce a deep engraving and a coloring in one and the same operation with a femtosecond laser on materials such as ceramics (such as alumina or zirconia for example), ruby or sapphire. However, in contrast to the aforementioned metals, the conditions used to generate the coloring lead to a saturation of the ablation and it is therefore difficult to obtain a recess of substantial depth (≧40 μm).

For these materials, the following procedure is preferably followed: first engraving is carried out under a first set of parameters, then a last pass is carried out under a second set of parameters in order to finish the engraving and produce the coloring. The parameters modified may include the degree of overlap and the type of scan used. Thus, a simple scan seems to be advantageous if it is desired to obtain a white colored recess bottom for a ceramic, a sapphire or a ruby.

For example, a color is said to be white when the CIE Lab L*a*b* index has a value such that L*>90.

Once again, the machining conditions and the parameters will have to be adjusted depending on the type of material and the femtosecond laser machining system considered. Examples are given below for ruby and sapphire by way of illustration.

Trials on ruby have allowed recesses to be obtained with a white deposit on the recess bottom. What is important is to use a substantial degree of overlap and a high power to obtain the coloring.

The parameters used for the trials on ruby were the following:

TABLE 5
Conditions used in the coloring trials on ruby.

| | Average diameter | | |
|---|---|---|---|
| P on the | of the beam at | Repetition | Scanning |
| target [W] | the target [μm] | rate [kHz] | strategy |
| 2.40 | 28.4 | 10 | Simple hatch |
| | | Distance | |
| Pitch of the | Scanning | between two | Number of |
| scan [mm] | speed [mm/s] | pulses [μm] | passes |
| 0.003 | 6.3 | 0.63 | 1 |

The process is therefore different than for the metal materials (steel, Au, Pt) insofar as the coloring is preferably produced in the last engraving/machining pass using different parameters from those of the preceding passes that allow a substantial engraving to be obtained. Typically, the scanning speed is more than 10 times slower for the coloring than for the engraving (for example, 6.3 mm/s for the engraving/coloring step and 75 mm/s for the engraving without coloring). The color obtained is white, giving an excellent contrast between the red ruby and the white recess bottom, with a very good esthetic rendering.

In the trials, in the last combined engraving and coloring pass, the degree of longitudinal overlap is higher than for steel, about 97.2%; the degree of lateral overlap is also higher than for steel, about 86.6%. In the engraving passes without coloring, the degree of longitudinal overlap is 66.8% and the degree of lateral overlap is 45.8%.

Trials on sapphire have also allowed recesses to be obtained with a white deposit on the recess bottom. What is important is to use a substantial degree of overlap and a high power to obtain the coloring.

TABLE 6
Conditions used in the engraving and coloring trials
on sapphire. The average recess depth is 15 μm.

| | Average diameter | | |
|---|---|---|---|
| P on the | of the beam at | Repetition | Scanning |
| target [W] | the target [μm] | rate [kHz] | strategy |
| 4.0 | 28.4 | 60 | Simple hatch |
| | | Distance | |
| Pitch of the | Scanning | between two | Number of |
| scan [mm] | speed [mm/s] | pulses [μm] | passes |
| 0.003 | 6 | 0.1 | 1 |

In the trials, in the last combined engraving and coloring pass, the degree of longitudinal overlap is higher than for steel, about 99.6%; the degree of lateral overlap is also higher than for steel, about 86.6%. In the engraving passes without coloring, the scanning speed is higher and the pitch is larger: the degree of longitudinal overlap is 94.8% and the degree of lateral overlap is 45.8%.

Of course, the conditions must be adjusted depending on the type of material and on the femtosecond laser machining system (laser, wavelength of the beam, pulse length, fluence, optical system, scan head, etc.) considered. In particular, the fluence, the degree of longitudinal and lateral overlap and the scanning strategy will need to be optimized for each material, especially depending on the equipment and/or the optical assembly used.

For these materials as well it is also possible, by virtue of the femtosecond laser, to cleanly engrave a layer deposited on a surface, such as for example a layer of photoresist or a thin film, for example a thin film deposited by electrodeposition, or PVD, or CVD or any other comparable process, then to engrave the base material. This for example makes it possible, in one and the same femtosecond laser machining operation, to engrave a ceramic component coated with a electrodeposited gold layer and to engrave and color the bottom of the recess.

The table below summarizes important parameters for obtaining the combined simultaneous engraving and coloring effect by femtosecond laser machining with typical values, given by way of example, for the various types of material studied.

| Parameter | Steel | Au/Pt | Ceramic |
|---|---|---|---|
| Lateral pitch | 10 μm | 30 μm | <10 μm |
| Degree of lateral overlap | ~50% | ~0% | >60% |
| Degree of longitudinal | >90% | >95% | >95% |
| overlap | | | |
| Scan | Simple | Simple | Simple |
| | or | | |
| | cross | | |
| Prior engraving step to | | | |
| obtain a substantial depth | No | No | Yes |
| (≧40 μm) | | | |

For each class of material there are advantageous combinations of the degree of lateral overlap:
steels, titanium: lateral overlap between 0 and <100% (i.e. strictly below 100%), in particular between 20 and <100%, preferably between 50 and <100%;
precious metals, especially gold and platinum: substantially zero;
ceramics, especially ruby: between 50 and <100%, preferably between 80 and <100%, even between 90 and <100%.

Of course, a femtosecond pulsed laser other than that used in the trials could provide substantially equivalent results, for example a laser with a different pulse length and/or wavelength and/or a different beam diameter. The process parameters (degree of overlap, scanning speed, power, average energy) will have to be adapted if the need arises.

The process allows a metallic or ceramic component to be engraved and a colored engraving bottom to be obtained in a single operation of machining with a femtosecond pulsed laser.

Preferably, the machining conditions used for the engraving and for the coloring are similar, even identical. However, it is also envisionable to carry out the engraving with a first set of parameters, and to carry out the coloring combined with an engraving subsequently with a second set of parameters.

The color produced on a metallic component, especially on a material such as steel or a precious metal, is preferably black, even dark black, even equivalent to that obtained by an electrochemical engraving operation followed by a Cr(VI) treatment.

The color produced on a ceramic component, especially on sapphire, ruby, alumina or zirconia, is preferably white.

Composition or the steels tested

| [wt %] | Fe | Ni | Cr | Mn | Mo | Cu | N | C |
|---|---|---|---|---|---|---|---|---|
| 904L | 51 | 24-26 | 19-21 | — | 4-5 | 1-2 | 0.04-0.15 | <0.06 |
| P558 | 69.3 | — | 17 | 10 | 3 | — | 0.49 | 0.2 |

Composition of the gold alloys tested

| [wt %] | Au | Ag | Cu | Pt | Pd | Fe |
|---|---|---|---|---|---|---|
| Yellow | 75 | 12.5 | 12.5 | | | |
| gold | | | | | | |
| Pink gold | ≧75 | | ≧18 | ≧0.5 | | |
| according | | | | | | |
| to | | | | | | |
| EP1512765 | | | | | | |
| Gray gold | 75 | | 4 | | 15 | 6 |

The removal of material resulting from the engraving and coloring process according to the invention always leads to a recess of average depth larger than or equal to 4 μm per pass, in particular larger than or equal to 8 μm per pass, being produced. The expression “average depth” is here understood to mean the height difference between the arithmetic means of the ordinate values of roughness-profile points measured on the bottom of the recess (zone affected by the process according to the invention) on the one hand, and on the unprocessed surface near the recess, on the other hand.

Alternatively, the removal of material resulting from the engraving and coloring process according to the invention always leads to a recess of minimum depth larger than or equal to 4 μm per pass, in particular larger than or equal to 8 μm per pass, being produced. The expression “minimum depth” is here understood to mean the depth measured between the unprocessed surface near the recess and the highest points on the engraving bottom.

1. A process for engraving an element, comprising applying to the element a laser beam having pulses which each last less than one picosecond, so as to machine or remove material from the element and color a machined bottom surface.

2. The process as claimed in claim 1, wherein:
the element is made of steel or of titanium and the diameter of the beam, the speed of scanning of the element and the repetition frequency of the pulses are chosen such that the degree of overlap in a first direction, especially a longitudinal direction, is higher than 85% or even higher than 90% or even higher than 92% or even higher than 94%; or
the element is made of a gold alloy or of a platinum alloy and the diameter of the beam, the speed of scanning of the element and the repetition frequency of the pulses are chosen such that the degree of overlap in a first direction, especially a longitudinal direction, is higher than 90% or even higher than 95%; or
the element is made of ceramic, of ruby or of sapphire and the diameter of the beam, the speed of scanning of the element and the repetition frequency of the pulses are chosen such that the degree of overlap in a first direction, especially a longitudinal direction, is higher than 90% or even higher than 95%.

3. The process as claimed in claim 1, wherein:
the element is made of steel or of titanium and the diameter of the beam, the speed of scanning of the element and the repetition frequency of the pulses are chosen such that the degree of overlap in a second direction, especially a lateral direction, is comprised between 0% and <100%, in particular between 20% and <100% and preferably between 50% and <100%; or
the element is made of a gold alloy or of a platinum alloy and the diameter of the beam, the speed of scanning of the element and the repetition frequency of the pulses are chosen such that the degree of overlap in a second direction, especially a lateral direction, is zero or substantially zero; or
the element is made of ceramic, of ruby or of sapphire and the diameter of the beam, the speed of scanning of the element and the repetition frequency of the pulses are chosen such that the degree of overlap in a second direction, especially a lateral direction, is comprised between 50% and <100%, preferably between 80 and <100% or even between 90 and <100%.

4. The process as claimed in claim 1, wherein the operating parameters of the laser beam make it possible to machine or remove material from the element and to color the machined bottom surface.

5. The process as claimed in claim 1, wherein the removal of material and the coloring are achieved simultaneously.

6. The process as claimed in claim 1, wherein the regions of impact on the element of two pulses partially overlap, in particular the regions of impact on the element of two successive pulses partially overlap.

7. The process as claimed claim 1, wherein the diameter of the beam, the speed of scanning of the element and the repetition frequency of the pulses are chosen such that the degree of overlap in a first direction, especially a longitudinal direction, is higher than 90% or even higher than 92% or even higher than 94%.

8. The process as claimed in claim 1, wherein the diameter of the beam, the speed of scanning of the element and the repetition frequency of the pulses are chosen such that the degree of overlap in a first direction, especially a longitudinal direction, is lower than 100% or even lower than 99.8%.

9. The process as claimed in claim 1, wherein the element is made of steel, especially 904L steel or P558 steel or of titanium.

10. The process as claimed in claim 1, wherein the element is made of a precious material, especially of an alloy of 18 carat gold or of an alloy of Pt950 platinum.

11. The process as claimed in claim 1, wherein the element is made of ceramic, of ruby or of sapphire.

12. The process as claimed in claim 1, wherein the removal of material causes a recess to be produced with an average depth larger than or equal to 4 μm per pass and in particular larger than or equal to 8 μm per pass.

13. The process as claimed in claim 1, wherein application of the laser beam results, on the element, in a power density higher than 3×10¹² W/cm², even higher than 5×10¹² W/cm₂.

14. An element, in particular a timepiece element, especially a watch element, obtained by implementing the process as claimed in claim 1.

15. An element, in particular an element of a timepiece exterior, especially a flange, bezel, case, or glass, or a wristlet element, obtained by implementing the process as claimed in claim 1.

16. A clock mechanism comprising an element as claimed in claim 14.

17. A timepiece, in particular a watch, comprising a mechanism as claimed in claim 16.

18. A clock mechanism comprising an element as claimed in claim 15.

19. A timepiece, in particular a watch, comprising a mechanism as claimed in the preceding claim 18.

20. The process as claimed in claim 2, wherein:
the element is made of steel or of titanium and the diameter of the beam, the speed of scanning of the element and the repetition frequency of the pulses are chosen such that the degree of overlap in a second direction, especially a lateral direction, is comprised between 0% and <100%, in particular between 20% and <100% and preferably between 50% and <100%; or
the element is made of a gold alloy or of a platinum alloy and the diameter of the beam, the speed of scanning of the element and the repetition frequency of the pulses are chosen such that the degree of overlap in a second direction, especially a lateral direction, is zero or substantially zero; or
the element is made of ceramic, of ruby or of sapphire and the diameter of the beam, the speed of scanning of the element and the repetition frequency of the pulses are chosen such that the degree of overlap in a second direction, especially a lateral direction, is comprised between 50% and <100%, preferably between 80 and <100% or even between 90 and <100%.
